(19) United States
(12) Patent Application Publication
(10) Pub. No.: US 2015/0321639 A1
(43) Pub. Date: Nov. 12, 2015

(54) Anchorage Device

(71) Applicant: Infa-Secure Pty Ltd, Emu Plains (AU)

(72) Inventor: Richard Horsefall, Emu Plains (AU)

(73) Assignee: INFA-SECURE PTY LTD, Emu Plains (AU)

(21) Appl. No.: 14/651,234

(22) PCT Filed: Dec. 11, 2013
(86) PCT No.: PCT/AU2013/001446

§ 371 Date: Jun. 11, 2015

(30) Foreign Application Priority Data
Dec. 11, 2012 (AU) 2012905404

(51) Int. Cl. B60R 22/10; A44B 13/00; A44B 13/02; A44B 11/28

(52) U.S. Cl. CPC B60R 22/105; A44B 11/28; A44B 13/0029; A44B 13/02

(57) ABSTRACT

There is disclosed an anchorage device (80) for releasably attaching a tethering system of a child safety seat to a vehicle anchorage point, comprising: a body (81) having an open hook portion (82) at one end configured to engage with a fitting provided on the vehicle anchorage point and a slotted portion (83) for facilitating connection with the tethering system; a retainer member (86) pivotally mounted to said body (81) and movable between a closed position wherein the retainer member (86) cooperates with the open hook portion (82) to securely engage with the fitting and an open position, wherein the retainer member (86) is positioned distal to said open hook portion (82) to facilitate disengagement of the anchorage device with the fitting; wherein the retainer member (86) comprises a closing member (86a) configured to co-operate with the open hook member (82) when in the closed position and a locating member (86b) integrally formed with said closing member (86a), the locating member (86b) is configured to locate the fitting within the open hook portion (82) of the body (81) when the retainer member (86) is in the closed position.

### RELATED APPLICATION

The present application claims priority from Australian Provisional Patent Application No. 2012905404, filed 11 Dec. 2012, the entire contents of which are incorporated herein by reference.

### FIELD OF INVENTION

The present invention relates generally to an anchorage device for securing a tether system of a child safety seat to a dedicated anchorage point provided on a vehicle, in particular, to an anchorage device for securing an upper tether system of a child safety seat to the dedicated vehicle anchorage point.

### BACKGROUND OF THE INVENTION

The use of child safety seats to accommodate infants and young children whilst travelling in a vehicle is common throughout the world. Most countries have established various laws and regulations that dictate the manner in which infants and children are to be transported in vehicles, and the types of restraints that are acceptable. Most such laws require the infant/child to be restrained in a dedicated and approved child safety seat that is anchored or otherwise secured to a rear seat of the vehicle. The child safety seat may include a dedicated harness that restrains the child in position within the seat, or the child safety seat may utilise the vehicle seat belt or a separate harness to restrain the child therein, depending upon the size and/or age of the child.

As such, there exist a variety of types of child safety seats that are approved for use with children of a variety of ages and/or sizes. These types can be broadly characterised as follows. Type A seats typically refer to rear facing seats or capsules suitable for accommodating babies/infants up to around 6 months of age and/or 70 cm in length and up to 12 kg. Type B seats typically refer to forward facing seats used to accommodate toddlers and young children from approximately 6 months to 4 years, or from 8-18 kg. Type E seats typically refer to booster seats and booster cushions used to accommodate children between 4-8 years old, or approximately from 14-32 kg, and which are typically used in combination with the vehicle seat belt.

Many child safety seats include a tethering system that enables the seat to be tethered to a dedicated anchorage point provided on the vehicle. Typically, such tethering systems tether the upper region of the seat to the anchorage point to prevent or substantially reduce movement of the seat in a forward direction in the event of an accident or the vehicle coming to a sudden stop. The dedicated anchorage point is typically a point located on the vehicle to which an attachment, such as a bolt or similar fitting, is provided such that forces that may build up in the tethering system are transferred directly to the structure of the vehicle. In this regard, the tethering system typically employs a hook member or similar arrangement that attaches to a bolt or fitting located at the vehicle anchorage point.

For child safety seats that employ an upper tethering system, the tethering system also functions to locate and position the child safety seat in a desirable position in relation to the vehicle seat. In order to ensure that the child safety seat is installed on the vehicle seat in a safe and optimal manner, it is often required that the tethering system is initially attached to the vehicle anchorage point and subsequently tightened such that any slack present in the straps of the tethering system is removed. Thus, once installed, the child safety seat is securely retained in position on the vehicle seat. To further securely locate the child safety seat on the vehicle seat, the lower region of the child safety seat may be restrained by the vehicle seat belt and/or an isotype fitting.

A problem with child safety seats that employ such an upper tethering system is that if the seat is to be removed from the vehicle it is often difficult to disengage the hook member of the tethering system from the anchorage fitting provided in the vehicle anchorage point. This is typically due to the general configuration of the hook member used in the tethering system which typically uses a metal spring clip and may also use a retention device that clips over the fitting provided in the vehicle anchorage point. Hence, in order to disengage such a clip, it is typically required to loosen the straps of the tethering system sufficiently such that the clip can be manipulated appropriately to disengage from the anchorage fitting. Such an action typically requires significant effort on behalf of the parent or guardian seeking to use the child safety seat, and often requires both hands of the parent/guardian to manipulate the hook member, which is time consuming and frustrating. This is typically due to the fact that the action may require the hook member to be manipulated into a certain angle to enable the hook member to be disengaged from the anchorage fitting.

There is a need to provide an anchorage device that can be used in an upper tethering system of a child safety seat which can be easily engaged/disengaged with/from the vehicle anchorage point in a simple and convenient manner.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims.

Accordingly, in one aspect of the invention there is provided an anchorage device for releasably attaching a tethering system of a child safety seat to a vehicle anchorage point, comprising:
an open hook member configured to engage with a fitting provided on a vehicle anchorage point;
a closing member configured to co-operate with the open hook member to facilitate secure attachment of the device to the vehicle anchorage point;
an activation member operable to engage with either the open hook member or the closing member to facilitate movement of either the open hook member or the closing member to an open position whereby a gap is formed between the open hook member and the closing member to detach the device from the vehicle anchorage point; and
a biasing means for applying a biasing force to either the open hook member or the closing member such that under the biasing force the closing member cooperates with the open hook member to facilitate secure attachment of the device to the vehicle anchorage point.

In one embodiment, the activation member is operable to move the closing member with respect to the open hook member to form said open position.

The closing member may be located on the activation member. The activation member may be a slide member mounted on the open hook member and the closing member may be a projection formed on the slide member.

In one embodiment, when the slide member is in a first position the projection may cooperate with the open hook member to close the open hook member, and when the slide member is in a second position the projection may be located remote from the open hook member to form the gap to facilitate detachment between the device and the vehicle anchorage point.

Movement of the slide member between the first position and the second position may be in the form of sliding movement performed along a common plane. A stopper may be provided on the open hook member to engage with the slide member when the slide member is in the first position. The stopper may be in the form of a projection that extends from a surface of the open hook member and engages with a recess provided in the slide member when the slide member is in the first position. The biasing means may bias the slide member into the first position.

In another embodiment, the activation member may be operable to move the open hook member with respect to the closing member to form said open position. The open hook member may be pivotally mounted with respect to the closing member.

In one form, the activation member may be provided on the open hook member. The activation device may be a lever portion formed at one end of the open hook member that is deflected to impart pivotal motion to the open hook member to move the open hook member between a closed position where the open hook member co-operates with the closing member and an open position where the open hook member is located remote from the closing member. In another form the activation device may be a slide member slidably movable along the open hook member.

In yet another embodiment, the open hook member and the closing member each form a top and bottom jaw member. Each top and bottom jaw member is pivotally mounted with respect to each other and are movable between a closed position whereby the jaw members are securable about a fitting of a vehicle anchorage point, and an open position, whereby the anchorage device is removable from a fitting of a vehicle anchorage point.

A biasing means may be provided to return the top and bottom jaw members to a biased position in the absence of an opening force. The biased position may be a closed position. The jaws may be movable between the open and closed position by way of a slide member mounted between the top and bottom jaw members, such that movement of the slide member in a first direction will result in the jaw members opening.

According to another aspect of the present invention, there is provided an anchorage device for releasably attaching a tethering system of a child safety seat to a vehicle anchorage point, comprising:
a body having an open hook portion at one end configured to engage with a fitting provided on the vehicle anchorage point and a slotted portion for facilitating connection with the tethering system;
a retainer member pivotally mounted to said body and movable between a closed position wherein the retainer member cooperates with the open hook portion to securely engage with the fitting and an open position, wherein the retainer member is positioned remote from said open hook portion to facilitate disengagement of the anchorage device with the fitting;
wherein the retainer member comprises a closing member configured to co-operate with the open hook member when in the closed position and a locating member integrally formed with said closing member, the locating member is configured to locate the fitting within the open hook portion of the body when the retainer member is in the closed position.

The anchorage device may further comprise a biasing means for biasing the retainer member into the closed position. In one form, the biasing means may comprises a torsion spring or a compression spring located between said retainer member and said body to apply a force against the retainer ember to maintain the retainer member in the closed position. In another form, the biasing means may be formed due to the flexible resilient material of the retainer member.

The body may comprise a recess formed therein. The recess may be configured to accommodate the locating member of the retainer member as the retainer member moves from said closed to position to said open position.

One or more cover members may be provided to fit over an upper and lower surface of the body. The cover members may be configured to cooperate so as to securely locate the retainer member in position with respect to the hook portion of the body.

### BRIEF DESCRIPTION OF THE DRAWINGS

The invention may be better understood from the following non-limiting description of preferred embodiments, in which:

FIG. 1 is a side view of a conventional anchorage device anchoring an upper tethering system of a conventional child safety seat to a dedicated vehicle anchorage point;

FIG. 2 is a side view of an anchorage device in accordance with an embodiment of the present invention;

FIG. 3 is a top view of the anchorage device of FIG. 2;

FIG. 4 is a cross-sectional side view of the anchorage device of FIG. 2 attached to a vehicle anchorage point;

FIG. 5 is a side view of the anchorage device of FIG. 2 immediately prior to the device being moved from a closed position into an open position;

FIG. 6 is a side view showing the anchorage device of FIG. 2 in an open position;

FIG. 7 is a side view of an anchorage device in accordance with another embodiment of the present invention;

FIG. 8 is a side view of the anchorage device of FIG. 7 movable between an open and a closed position;

FIG. 9 is a side view of an anchorage device in accordance with yet another embodiment of the present invention;

FIG. 10 is a side view of the anchorage device of FIG. 9 movable between an open and a closed position;

FIG. 11 shows a top perspective view of an anchorage device in accordance with yet another embodiment of the present invention;

FIG. 12 is a side view of the anchorage device of FIG. 11 in a closed position;

FIG. 13 is a side view of an anchorage device in accordance with yet another embodiment of the present invention in a closed position;

FIG. 14 is a side view of the anchorage device of FIG. 13 in an open position;

FIG. 15 is a perspective view of an anchorage device in accordance with another embodiment of the present invention;

FIG. 16 is a side view of the anchorage device of FIG. 15;

FIG. 17 is an exploded view of the anchorage device of FIG. 15;

FIG. 18 is a sectional side view of the anchorage device of FIG. 15 in a closed position;

FIG. 19 is a sectional side view of the anchorage device of FIG. 19 in an open position;

FIG. 20 is an exploded view of yet another embodiment of an anchorage device in accordance with the present invention;

FIG. 21 is a perspective view of yet another embodiment of an anchorage device in accordance with the present invention; and

FIG. 22 is an exploded view of the anchorage device of FIG. 21.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

While the present invention will be described in relation to its application for use in securing an upper tether system of a child safety seat to a dedicated vehicle anchorage location, the anchorage device could also be used in a variety of other applications as will be appreciated by those skilled in the art.

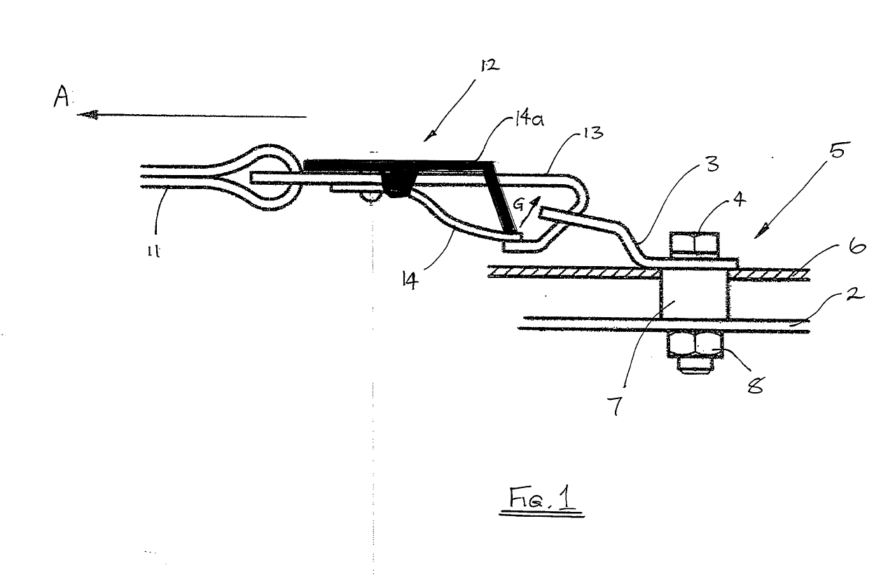

Referring to FIG. 1, there is shown a conventional prior art anchorage arrangement 10 for securing an upper tethering system 12 of a child safety seat to a dedicated vehicle anchorage point 5.

The vehicle anchorage point 5 typically includes a hole or recess formed in the vehicle body 2, to which a fitting 3 is secured by way of a bolt 4. The bolt 4 generally passes through the vehicle body 2 and the trim 6 of the vehicle, and a spacer 7 may be employed between the vehicle body 2 and the vehicle trim 6 as shown. A nut 8 is typically provided to engage with the threaded end of the bolt 4 to secure the fitting 3 in position above the vehicle trim 6 to receive the upper tethering system 12 of the child safety seat. In this regard, any forces acting on the fitting 3 through the upper tethering system 12 are transferred through the fitting 3 and bolt 4 to the body 2 of the vehicle.

The upper tethering system 12 generally comprises a strap 11 that attaches to the child safety seat and a clip member 13 that attaches to the fitting 3 as shown. The fitting 3 typically has a recess or hole (not shown) formed therein to receive the clip member 13. In the embodiment as shown, the clip member 13 is in the form of a hook that passes through the hole formed in the fitting 3. A retention device 14, such as a flexible elongate metal plate is provided to close off the hook portion of the clip member 13 such that the hook member 13 is closed and does not slip-off or otherwise inadvertently disengage with the fitting 3 when the tethering system 12 is loosened. A retainer element 14a may also be provided to retain the hooked portion of the clip member 13 at the front region thereof to prevent inadvertent removal of the clip member from the fitting 3.

As is shown in FIG. 1, in order to fit a child safety seat having the upper tethering system 12 to the vehicle, the clip member 13 is typically attached to the fitting 3 and the strap 11 tightened to remove any slack formed therein. It will be appreciated that to remove the child safety seat from the vehicle, it is necessary to disengage the tethering system from the anchorage point 5, by disengaging the clip member 13 from the fitting 3. In order to disengage the clip member 13 from the fitting 3, the retention device 14 and the retainer element 14a must be depressed by the user's fingers or thumbs and the clip member moved towards the fitting 3 and in an upward manner, such that the fitting can pass between the clip member 13 and the retention device 14. It will be appreciated that in a static position, the strap 11 is typically in a tightened state and thus pulls upon the clip member 13 in the direction of arrow ‘A’, thus providing resistance against any attempt to disengage the clip member 13. To overcome this resistance the user typically must loosen the strap 11 at the child safety seat to enable the clip member to be moved to disengage from the fitting 3. However, the presence of the retainer element 14a also requires that the user manipulate the clip member 13 such that it is at a suitable angle with respect to the fitting 3 such that the retention device 14 and the retainer element 14a can be successfully separated from the clip member 13 to enable the fitting to pass therebetween.

As can be seen in FIG. 1, in order to remove the clip member 13 from the fitting 3 both the retention device 14 and the retainer element 14a must be flexed away from contact with the clip member 13, as represented by arrow ‘G’. This action typically results in a restriction of the space which accommodates the fitting 3 which can obstruct removal of the clip member 13 from the fitting 3. Thus, the act of removing the clip member is further complicated.

As will be appreciated by those skilled in the art, the above-described process for removal of a conventional upper tethering system from a fitting of an anchorage point requires considerable effort on behalf of the user of the seat, typically a parent or guardian, which is further complicated by the fact that the space in which the user typically has to work, namely the parcel shelf or rear seat of the vehicle is limited.

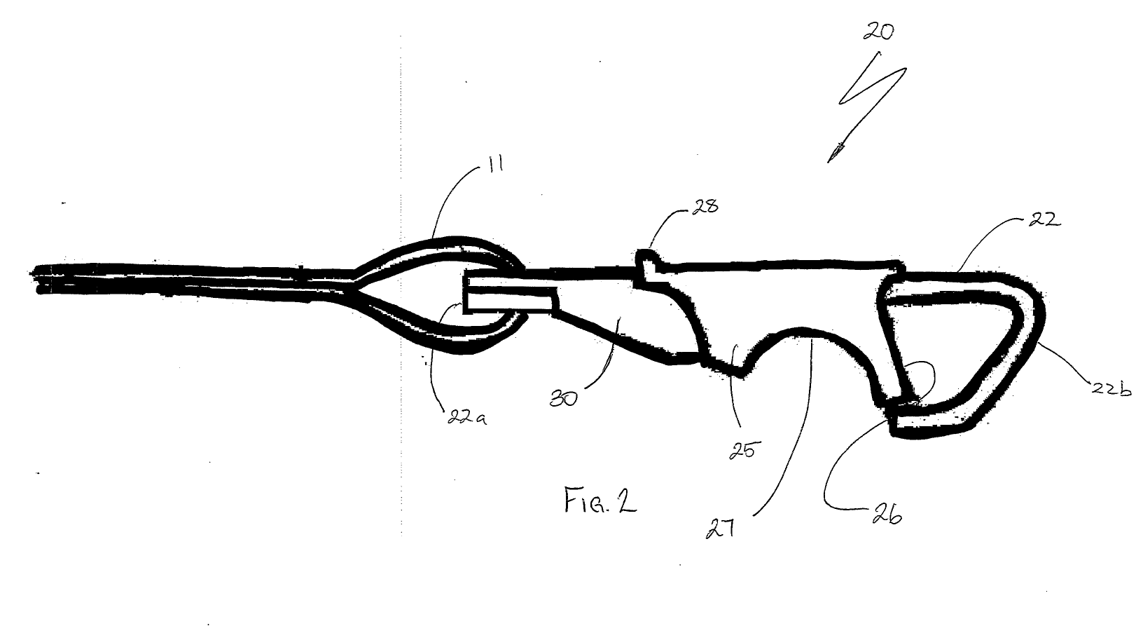

In order to address this problem, anchorage device 20 in accordance with an embodiment of the present invention is proposed, as is shown in FIGS. 2-8.

Referring firstly to FIG. 2, the anchorage device 20, generally comprises a hook member 22 that is similar in shape and configuration to the clip member 13 of the prior art device shown in FIG. 1. The hook member 22 is typically formed from a metal material, such as stainless steel, and has a thickness of between 3-5 mm, although other materials and thicknesses are also envisaged.

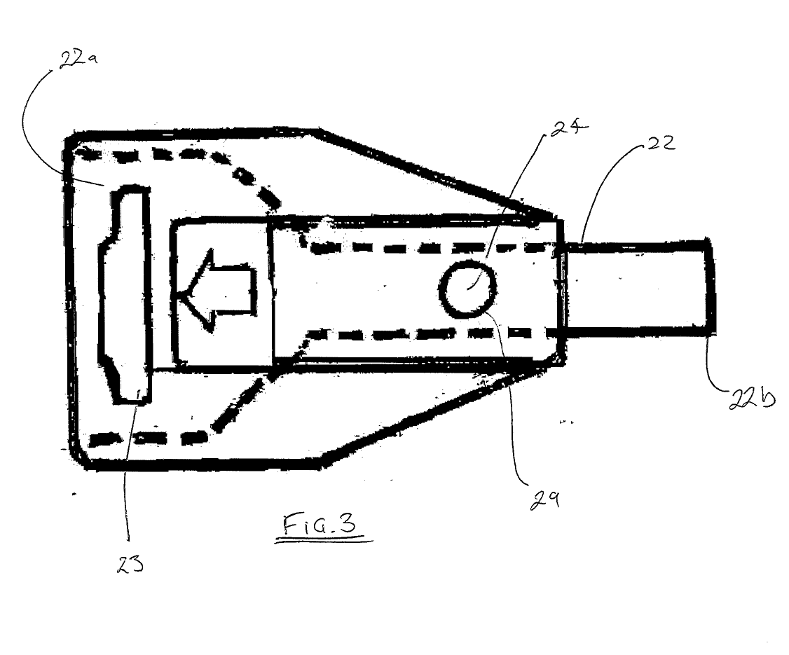

As can be more clearly seen in FIG. 3, the hook member 22 has a wide first end 22a that has a slot 23 formed therein to receive the strap 11 that is typically attached to an upper region of the child safety seat (not shown). The hook member 22 then tapers towards a narrow main portion that terminates at the second end 22b. A stopper 24 is provided on a surface of the narrow portion of the hook member 22. The stopper 24 is preferably provided on an upper surface of the hook member 22 and is in the form of a projection that projection above the upper surface of the hook member 22.

A slide member 25 is mounted on the hook member 22 as is shown in FIG. 2. The slide member 25 is configured to fit over the hook member 22 and has a central recess formed therein through which the hook member 22 is received to enable the slide member to move along the hook member 22 in a sliding manner. The undersurface of the slide member 25 has a face portion 26 that projects from a front edge thereof to act to close the hook member 22 when the slide member 25 is in an engaged position, as is shown in FIG. 2. In the engaged position, the slide member 25 is in a forward most position such that the face portion 26 is proximal the second end 22b of the hook member 22. This maintains the locating end of the fitting 3 in the frontal region of the hook member 22 A groove 27 is also formed in the undersurface of the slide member 25. The groove 27 is provided behind the face portion 26 and provides a means for enabling a user to grip the slide member 25 to move the slide member in a manner to be described in more detail below. The upper surface of the slide member 25 is substantially planar and has a ridge 28 formed towards a rear portion thereof. The ridge 28 also functions to aid in applying movement to the slide member 25 in a manner as will be discussed in more detail below.

As is shown more clearly in FIG. 3, a recess 29 is formed in the upper surface of the slide 25 to receive the stopper 24. In this regard, the recess 29 is shaped to conform to the shape of the stopper 24 and in the embodiment shown, the recess and the stopper as shown as being circular. It will be appreciated that the shape of the recess and stopper may vary to accommodate a variety of shapes and sizes as would be well understood by those skilled in the art. The recess 29 is located in the slide member 25 such that when the slide member is moved to the engaged position or forward most position, as is shown in FIGS. 2 and 3, the stopper 24 is received within the recess 29, to lock the slide member 25 in position. This will be discussed in more detail below.

A sleeve 30 is provided to extend over the rear portion of the hook member 22. The sleeve 30 is shaped to enable the slide member 25 to move in relation to the sleeve 30, such that the slide member 25 is in constant contact with the sleeve 30.

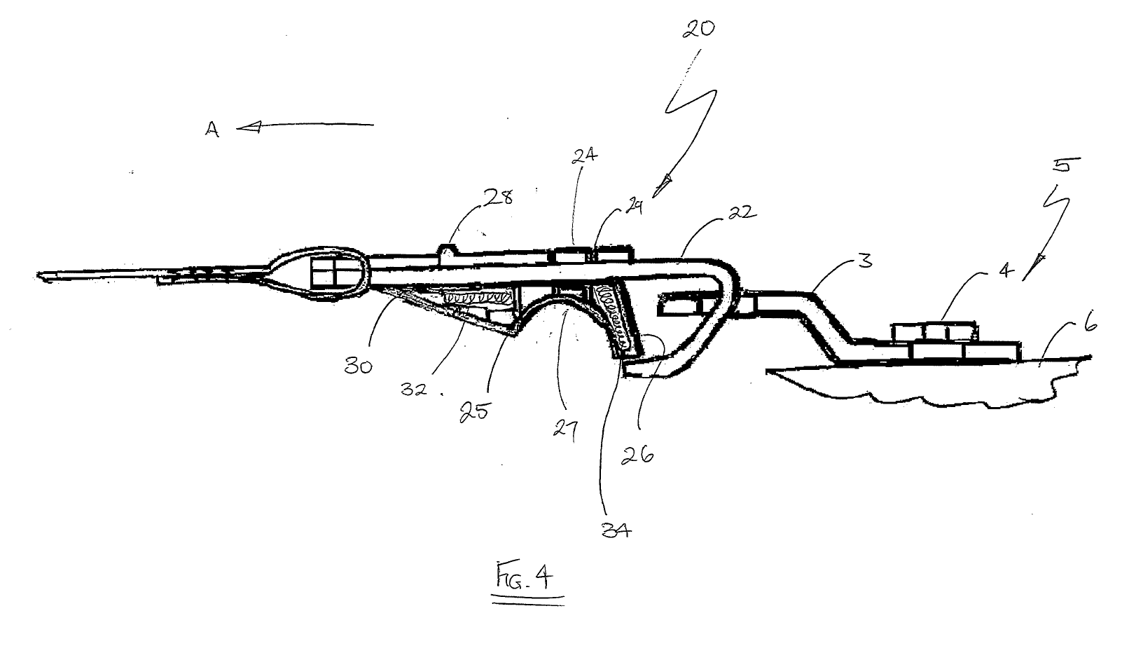

As is shown in FIG. 4, the manner in which the anchorage device 20 engages with a fitting 3 of a vehicle anchorage point 5 is shown. The anchorage device 20 is depicted in a closed or engaged position whereby the hook member 22 is received in the recess of the fitting 3 and the face portion 26 of the slide member 25 closes the hook portion 22 around the recess of the fitting 3. In this position, the stopper 24 is received within the recess 29 provided in the upper surface of the slide member 25, such that the slide member 25 is locked in position and is unable to move from the closed or engaged position.

In order to maintain the slide member 25 in the closed or engaged position, a first spring member 32 is mounted between the slide member 25 and the sleeve 30. The first spring member 32 is a tension spring and functions to provide a constant force to the slide member 25 to maintain the slide member in the closed or engaged position whereby the stopper 24 is received in the recess 29. Any attempt to slide the slide member 25 in the direction of arrow ‘A’ will result in the first spring member 32 compressing thereby storing potential energy to provide an increasing biasing force against such movement.

A second spring member 34 is also provided within the slide member 25. The second spring member 34 acts against the hook member 22 to maintain a constant biasing force to the slide member in a downward direction, or a direction towards the underside of the slide member 25. Such a constant biasing force formed by the second spring member 34 ensures that the stopper 24 remains within the recess 29 when the slide member is in the closed position, as shown in FIG. 4.

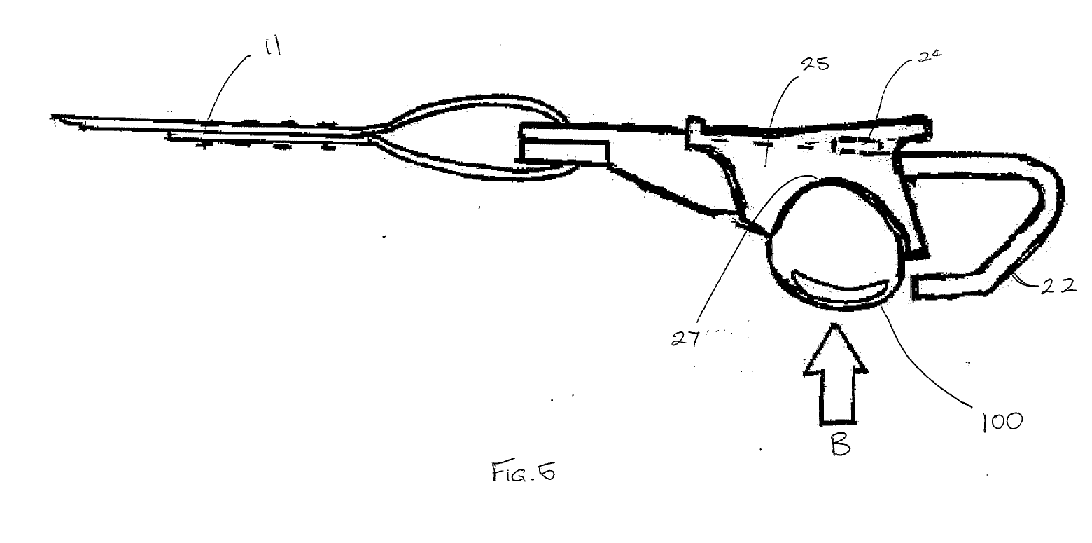

Referring to FIG. 5, to move the slide member 25 of the anchorage device 20 from the closed position of FIG. 4 to an open position so as to facilitate removal of the child safety seat, the user firstly places their finger 100 in the groove 27 as shown. By applying a force to the slide member 25 in the direction of arrow B, the biasing force of the second spring member 34 is overcome which enables the upper surface of the slide member 25 to lift from the surface of the hook member 22, thereby causing the stopper 24 to become released from the recess 29 formed in the upper surface of the slide member 25.

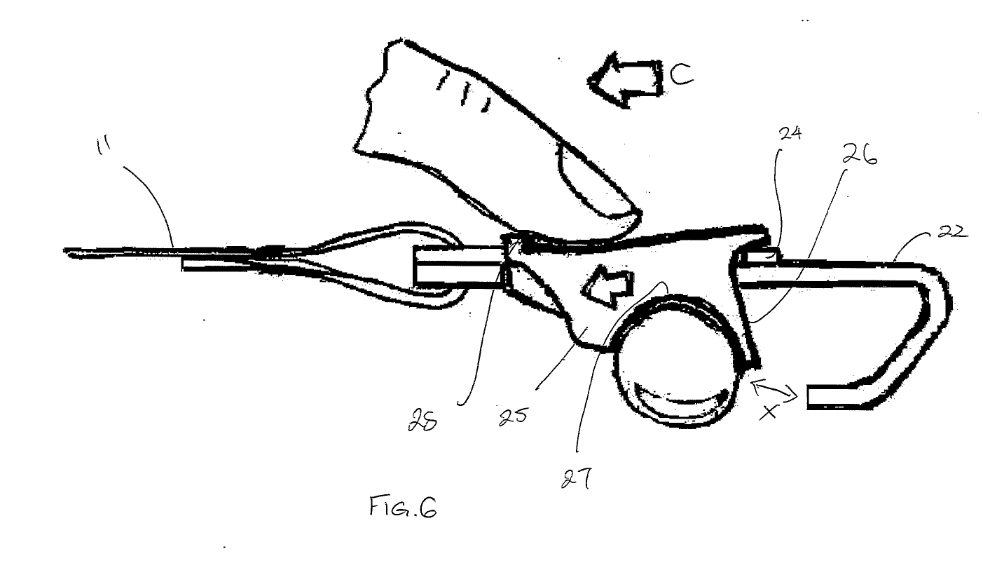

Once the stopper 24 is clear from the recess 29 of the slide member 25, the user can then use their thumb to push down on the ridge 28 to slide the slide member 25 in the direction of arrow ‘C’ (FIG. 6). In doing so, the face portion 26 of the slide member 25 becomes separated from the hook member 22 to form a gap ‘X’ that enables the anchorage device 20 to be released from the fitting 3 in a simple and effective manner.

Upon release of the force in the direction of arrow ‘C’ the biasing forces of the first spring member 32 and the second spring member 34 will cause the slide member 25 to return to the closed position of FIG. 4. In this regard, it will be appreciated that to re-attach the anchorage device 20 to the fitting 3, all that is required it to push the anchorage device down on the underside of the slide member to replicate the arrangement shown in FIG. 5 such that the slide member rises to form a gap through which the fitting 3 can pass.

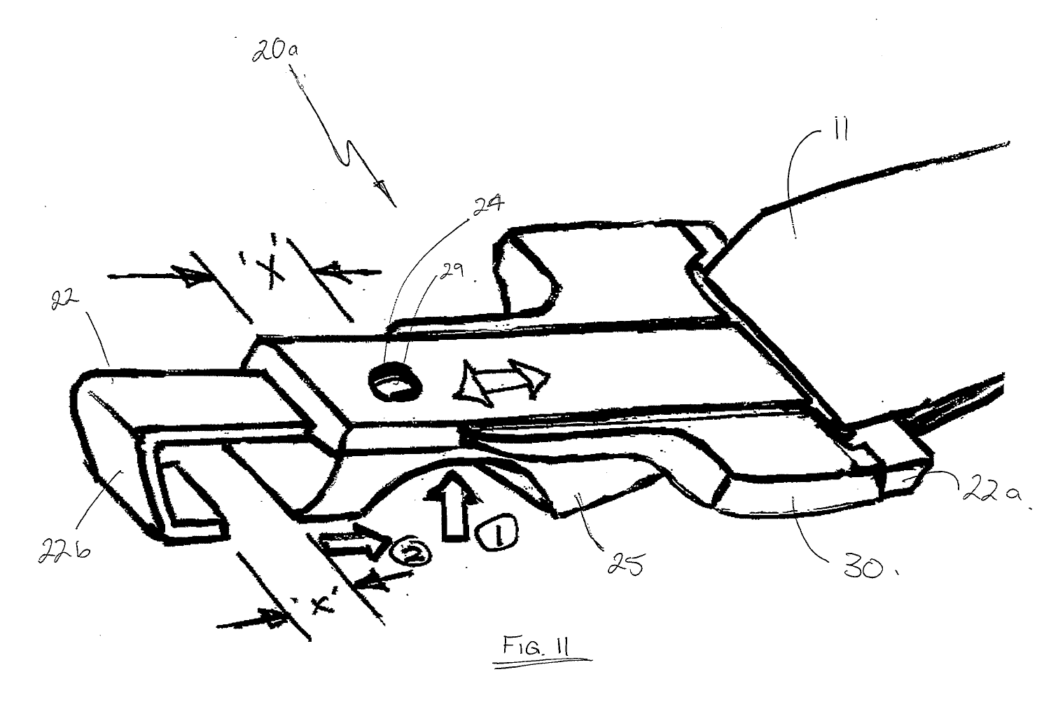

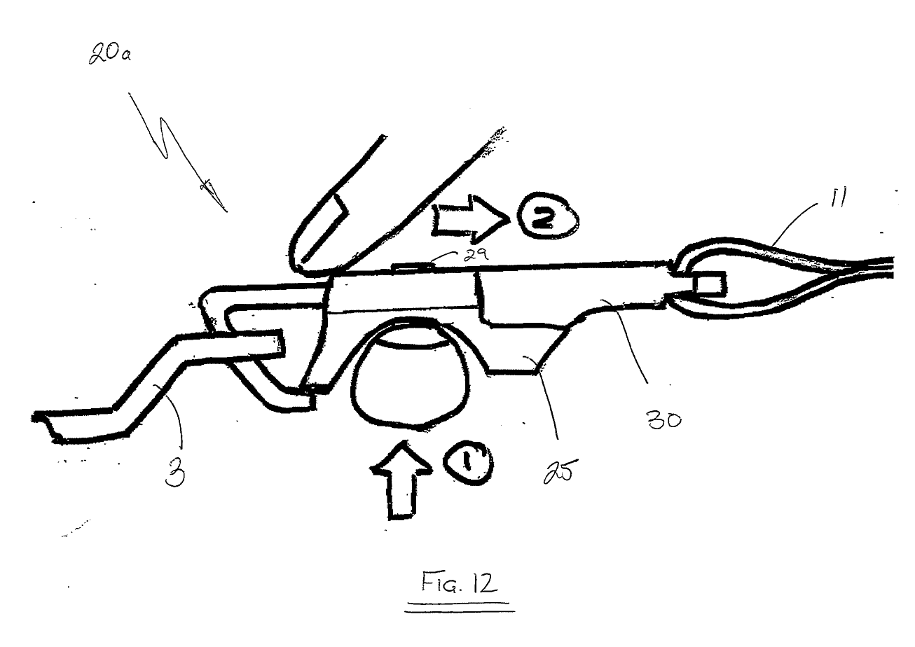

A variation of the embodiment of the anchorage device 20 shown in FIGS. 2-6 is shown as anchorage device 20a in FIGS. 11 and 12. In anchorage device 20a, the same reference numerals have been used as for those used above in relation to anchorage device 20, for reasons of clarity.

In anchorage device 20a, the device functions substantially the same as that described in relation to anchorage device 20; however, the user's thumb is to be positioned in a front position to move the slide member 25, as shown in FIG. 12. In FIG. 11, the anchorage device 20a is shown in the open position with the slide member 25 in the retracted position as shown by gap ‘X’, to facilitate removal of the anchorage device 20a from the vehicle anchorage fitting 3. In the embodiment of the anchorage device 20a, the slide member 25 is shown as being of a two-part construction that clips together in the manner as shown. It will be appreciated that other configurations for forming the slide member are also envisaged.

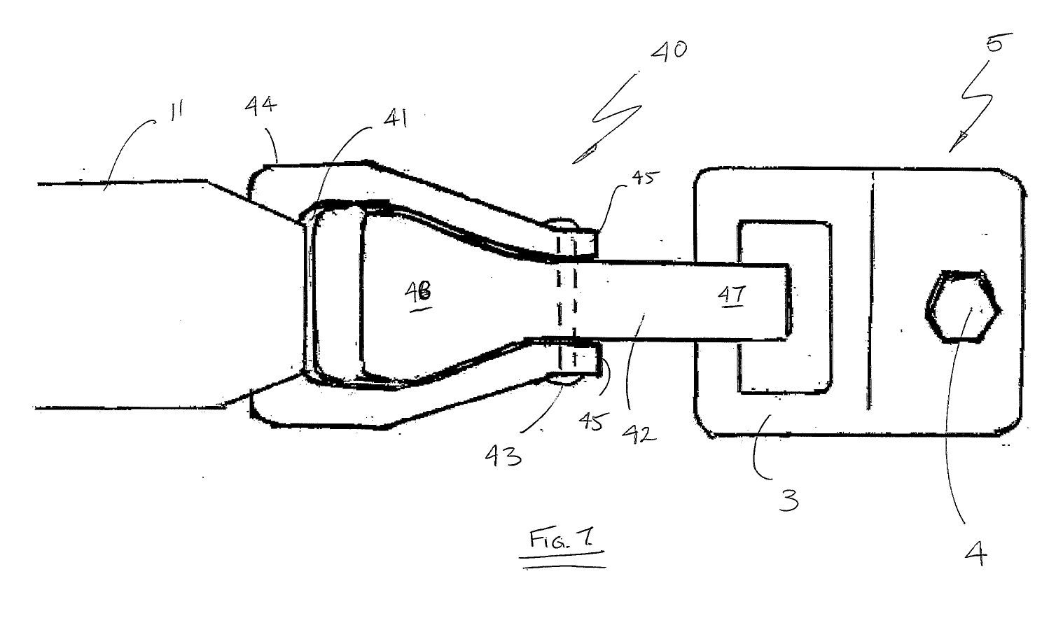

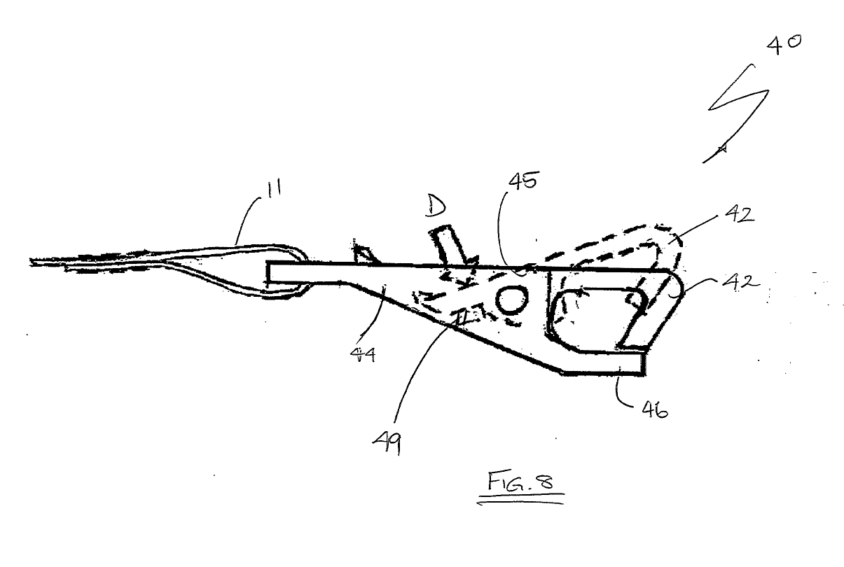

An alternative embodiment of an anchorage device 40 in accordance with the present invention is shown in FIGS. 7 and 8. In this embodiment, anchorage device 40 comprises a hook member 42 pivotally mounted to a body 44. Both the body 44 and the hook member 42 are typically made from a metal and either or both of the body 22 and hook member 42 may be encased in plastic.

The body 44 has a slot or opening 41 formed therein to receive the strap 11 of the tethering system, as is conventional. The slot or opening 41 is wide at one end to accommodate the strap 11 and tapers towards a narrow opening defined by a pair of spaced apart jaw members 45. As can be seen more clearly in FIG. 8, the body 44 has a foot portion 46 that projects centrally from below the jaw members 45 to provide a means for closing the hook member 42 in a manner to be described in more detail below.

The hook member 42 is mounted between the jaw members 45 of the body 44 by way of a pin 43. The hook member 42 comprises a hook portion 47 that projects beyond the body 44 in substantially the same plane as the foot portion 46 and a lever portion 48 that projects into the body 44, in the opposite direction to the hook portion 47. In this regard, the lever portion 48 is a continuation of the upper surface of the hook portion 47 in an opposite direction to the hook portion 47, and increases in width towards a distal end. The pin 43 provides a means by which the hook member 42 is able to pivot between a region between the lever portion 48 and the hook portion 47.

As is shown in FIG. 8, the hook member 42 is able to pivot about pin 43 between an open position whereby the end of the hook member 42 is separated from the foot portion 46 of the body 44, and a closed position whereby the end of the hook member 42 is in close proximity, or in contact with, the foot portion 46. A biasing means 49, such as a spring or the like, is mounted between the body 44 and an undersurface of the lever portion 48 of the hook member 42. The biasing means 49 functions to provide a return force against the lever portion 48 to maintain the hook member in the closed position, in the absence of an opening force in the direction of arrow ‘D’.

It will be appreciated that in the event that the user wishes to disengage the anchorage device 40 from the fitting 3, the user merely pushes on the lever portion 48 to raise the hook portion of the hook member 42 off the foot portion 46. The anchorage device 40 is then able to be removed simply and effectively.

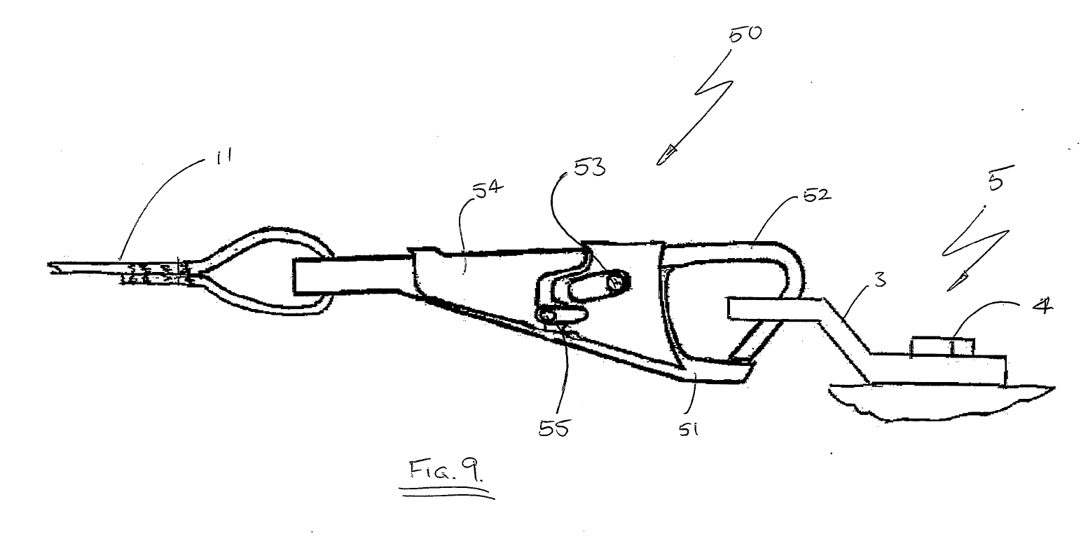

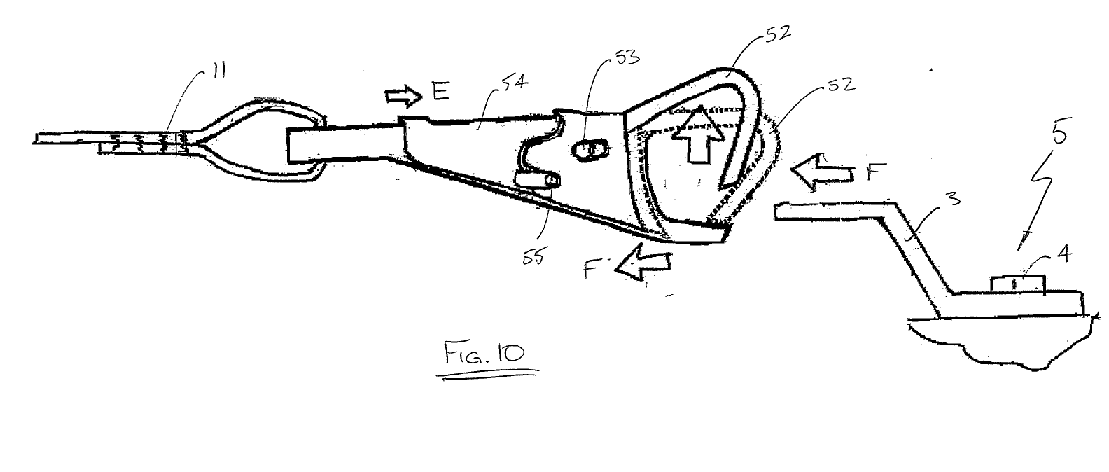

Yet another embodiment of an anchorage device in accordance with the present invention is shown in FIGS. 9-10. In this embodiment, the anchorage device 50 also employs a pivoting hook member 52 in a similar manner to that described above in relation to the embodiment of FIGS. 7 and 8. However, rather than depressing a lever portion of the hook member 52, a slider member 54 is provided to activate the pivoting motion of the hook member.

As in the embodiment previously described in relation to FIGS. 7 and 8, the hook member 52 is pivotally mounted to a body portion 51 by way of a pin 53. The slider member 54 is configured such that as it is moved in the direction of arrow E of FIG. 10, a downward force is applied on a rear lever portion of the hook member (not shown) which causes the hook member 52 to move away from the body portion 51 and into an open position as represented by the dashed lines. In this open position the anchorage device 50 is able to be removed from the fitting of the vehicle anchorage point 5 in a simple action.

As described in relation to the previous embodiments, the internal space of the device 50 may have a biasing means, such as a spring that biases the hook member 52 into the closed position in the absence of a force present on the slider member 54. A locking device 55 may be optionally provided to prevent sliding movement of the slider member 54 when the locking device 55 is in the locked position.

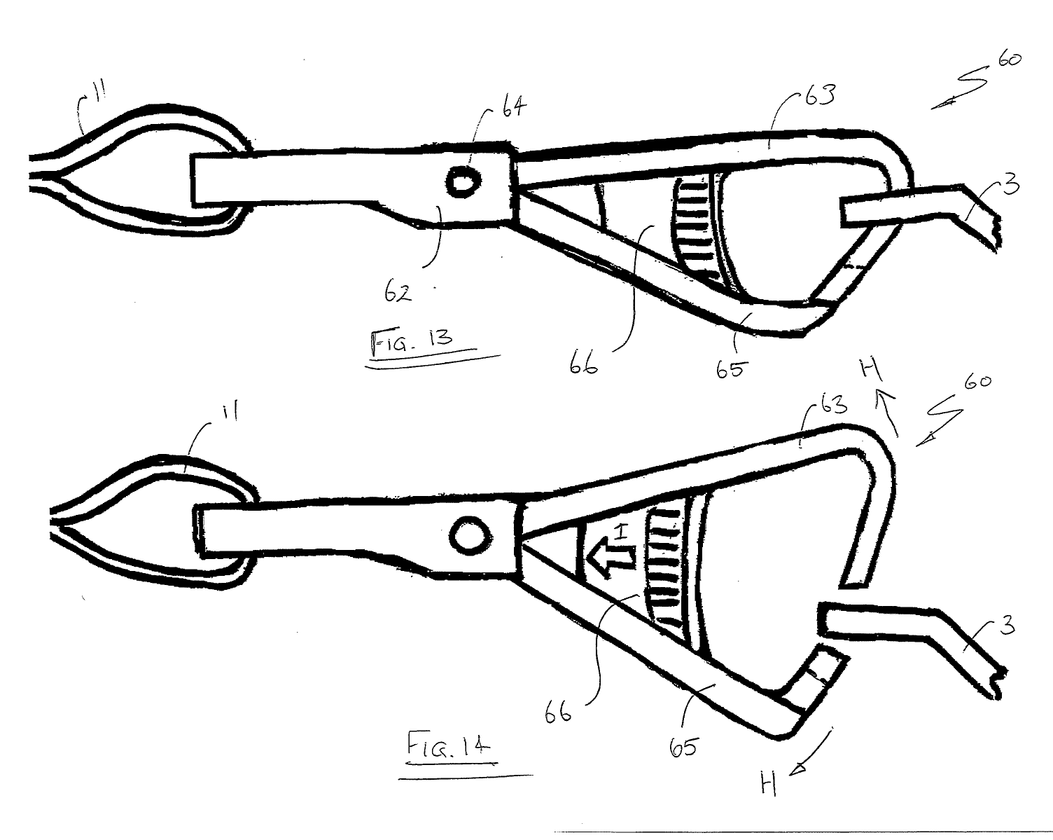

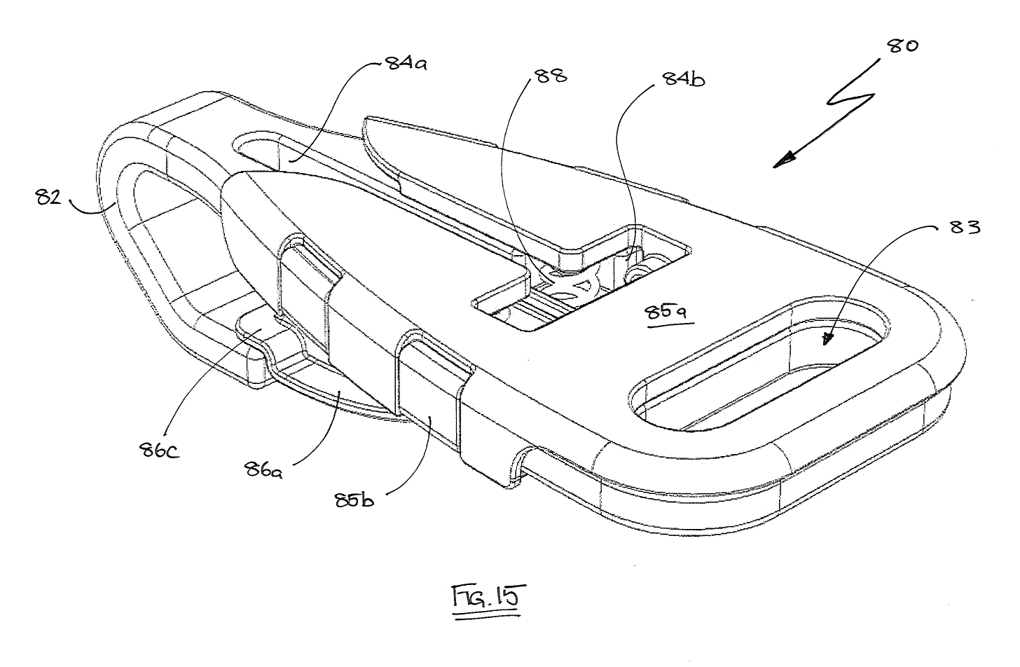

Referring to FIGS. 13 and 14, yet another embodiment of an anchorage device 60 according to the present invention is shown. In this embodiment, the device 60 comprises a body 62 to which a pair of jaw members 63, 65 are mounted to one end thereof. The other end of the body 62 has a slot (not shown) formed therein, through which the strap 11 of the tethering system of the child safety seat is received. A pin 64 extends through the jaw members 63, 65 and the end of the body 62, such that the jaw members 63, 65 are able to pivot about the pin 64 in the direction of arrows ‘H’ (FIG. 14). A biasing means (not shown) is provided to bias the jaw members 63 65 into an engaged position, as is shown in FIG. 13.

A slide member 66 is mounted between the jaw members 63, 65 such that movement of the slide member 66 in the direction of arrow ‘I’ causes the jaw members 63, 65 to separate against the biasing means. The ends of the jaw members 63, 65 overlap in the closed position of FIG. 13 to close about the fitting 3. It will be appreciated that in order to move the anchorage device 60 into an open position, the slide member 66 is moved in the direction of ‘I’ by the user, and once the user releases the slide member 66, it is returned to the biased position and the jaw members 63, 65 close. Such an arrangement provides for a simple means for opening and closing the anchorage device.

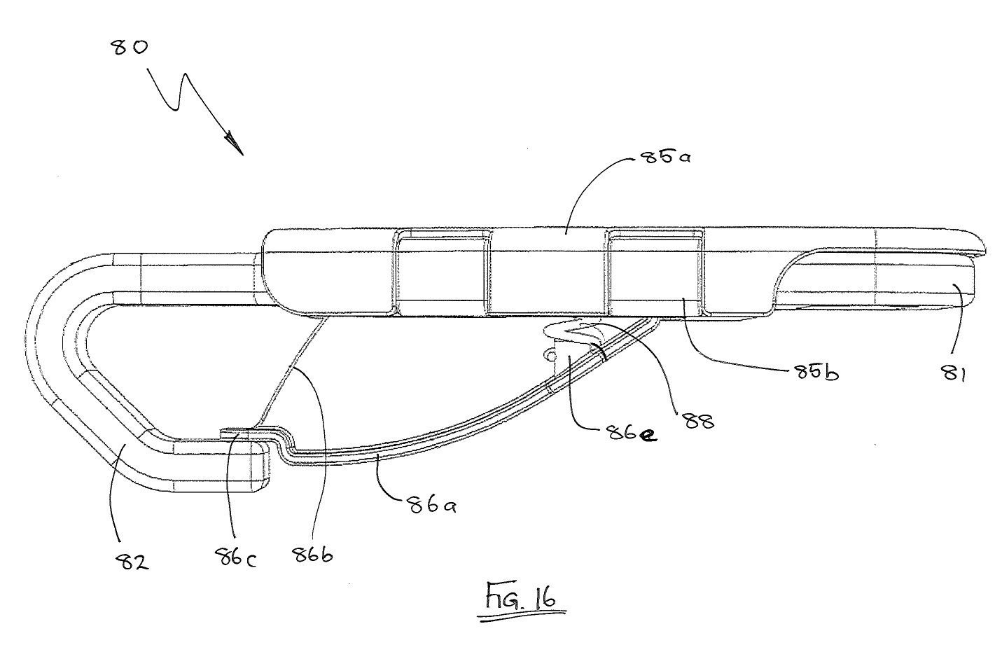

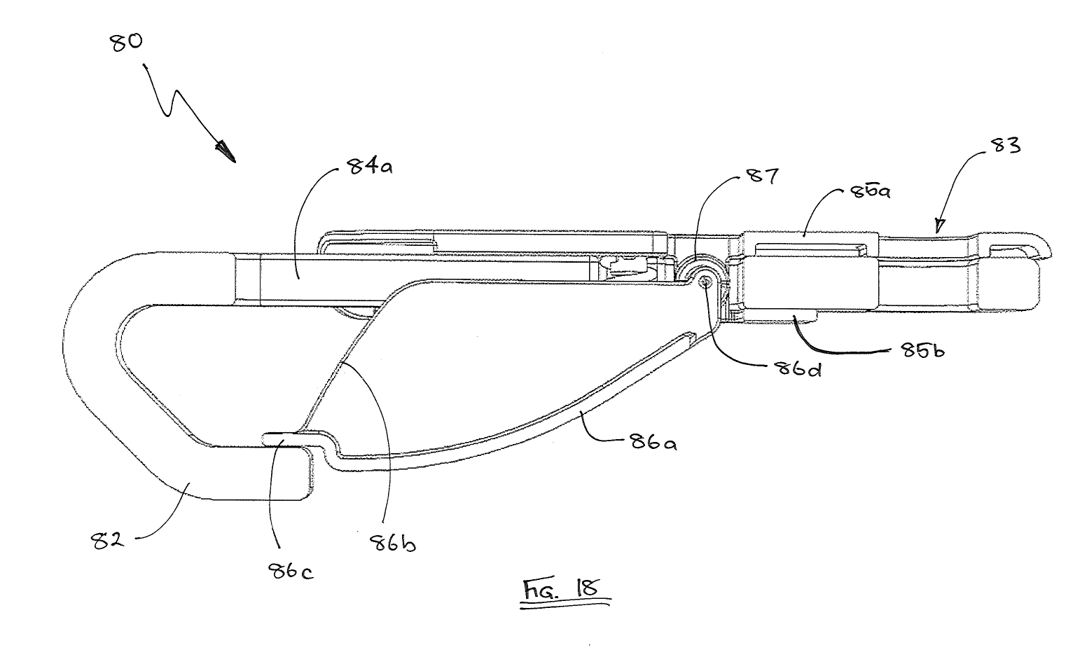

Referring to FIGS. 15-19, yet another embodiment of an anchorage device 80 in accordance with the present invention, is depicted As can be more clearly seen in the exploded view of the device in FIG. 17, in this embodiment the anchorage device 80 generally comprises a main body 81 having a hook portion 82 located at one end for engaging with a vehicle anchorage location or the like, and a laterally extending slot 83 provided at the opposing end. The laterally extending slot 83 is configured to receive a strap member (not shown) of an upper tethering system in the manner as discussed above in relation to the earlier embodiments.

The main body 81 also has a longitudinally extending recess 84 formed therein in a central region thereof that extends between the hook portion 82 and the slot 83. The recess 84 comprises a narrow slot portion 84a and a wider open portion 84b, the purpose of which will be described in more detail below.

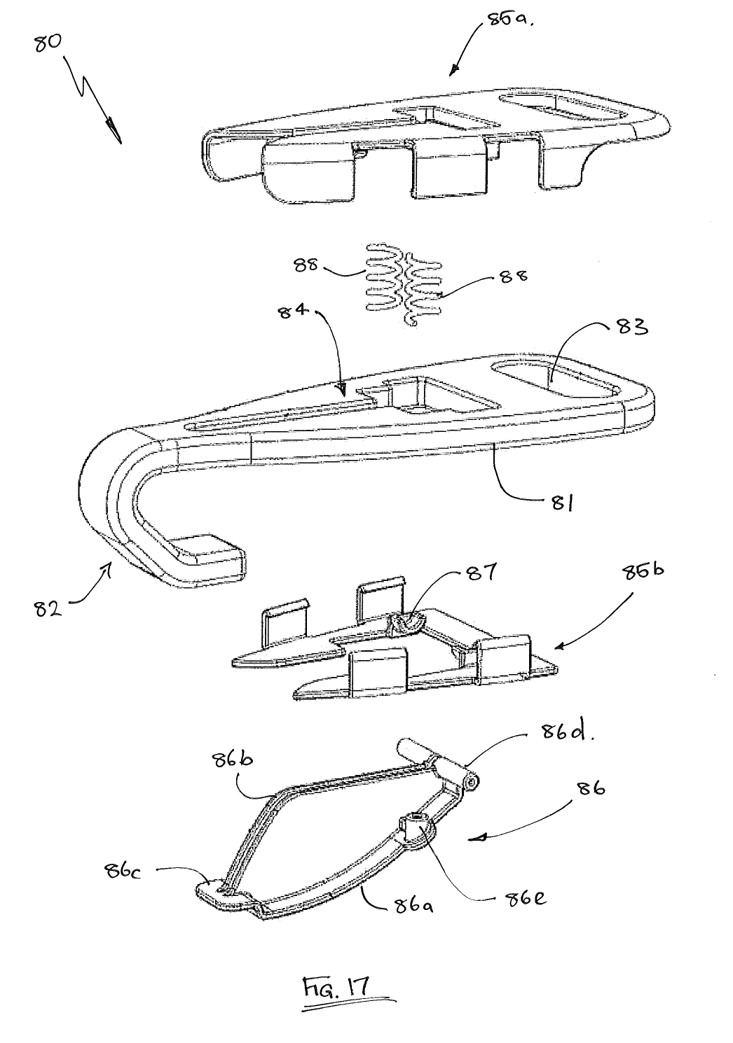

An upper cover member 85a and a lower cover member 85b are configured to fit about the main body 81 and engage therewith from an upper and lower surface respectively, as is shown in FIGS. 15 and 16. The upper cover member 85a and the lower cover member 85b are configured to interengage about the main body 81 so as to securely locate and position a retainer device 86 with respect to the hook portion 82 of the main body 81. The retainer device 86 is configured to cooperate with the hook portion 82 of the main body so as to close the hook portion when in a closed position and to open the hook portion when in an open position.

The retainer device 86 comprises an axle portion 86d, in the form of a pair of cylindrical projections which are shaped to be captured within mounting members 87 formed in the upper cover member 85a and lower cover member 85b. In this regard, when the upper cover member 85a and the lower cover member 85b are fitted to the main body, their respective mounting members cooperate to capture the axle portions 86d of the retainer device 86 to define a point about which the retainer device 86 can pivot between an open and closed position.

The retainer device 86 is biased into the closed position by way of a pair of compression springs 88 that are seated at one end thereof on a pair of seats 86e provided on the retainer device 86 and extend to contact the undersurface of the upper cover member 85a, as is shown more clearly in FIG. 15. In this arrangement the springs 88 function to exert a constant biasing force against the retainer device 86 that maintains the retainer device 86 in a closed position. Any attempt to move the retainer device 86 into an open position will result in the biasing force acting against the retainer device increasing, such that upon removal of the opening force, the retainer device 86 will return to its closed position.

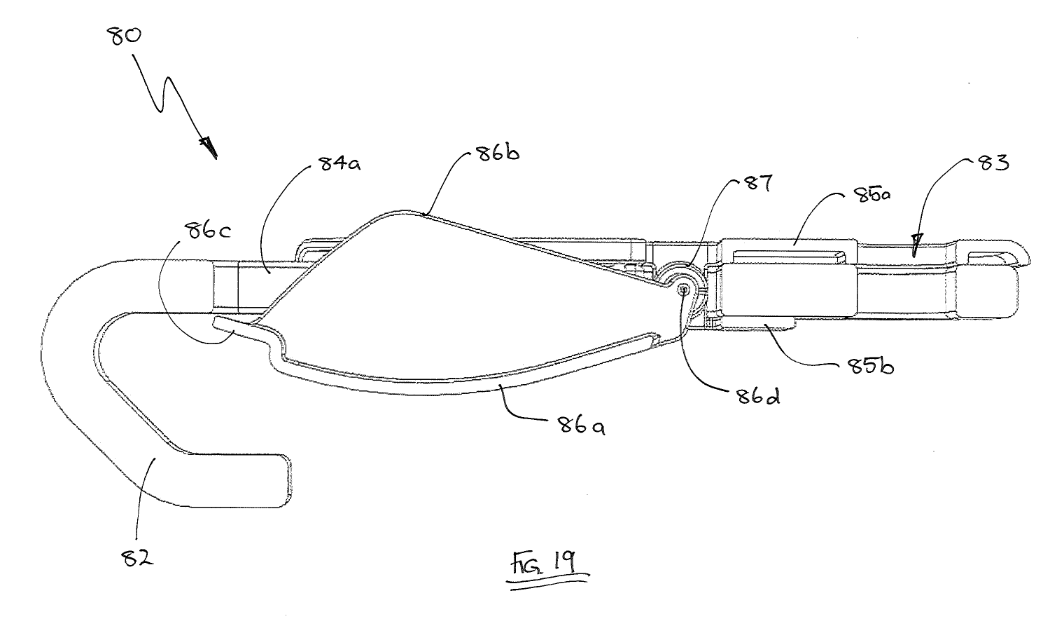

As is shown in FIG. 17, the retainer device 17 comprises a closing portion 86a and a locating portion 86b. The closing portion 86a has an end lip 86c which is configured to be seated on the end of the hook portion 82 of the main body 81 so as to close the hook portion 82, as is shown in FIG. 18. In this arrangement, the closing portion 86a provides an outer closing surface of the anchorage device 80, which is to be depressed by a user in order to open the anchorage device 80. The locating portion 86b is located inwardly of the closing portion 86a and functions to provide an internal wall such that the anchorage fitting to which the anchorage device 80 is attached, is maintained within the region of the hook portion 82 of the main body 81.

Referring to FIG. 18, the anchorage device 80 is depicted in the closed position, as may be the position when the anchorage device is attached to an anchorage fitting on a vehicle. In this arrangement the end lip 86c of the closing portion 86a is seated on the end of the hook portion 82 as shown.

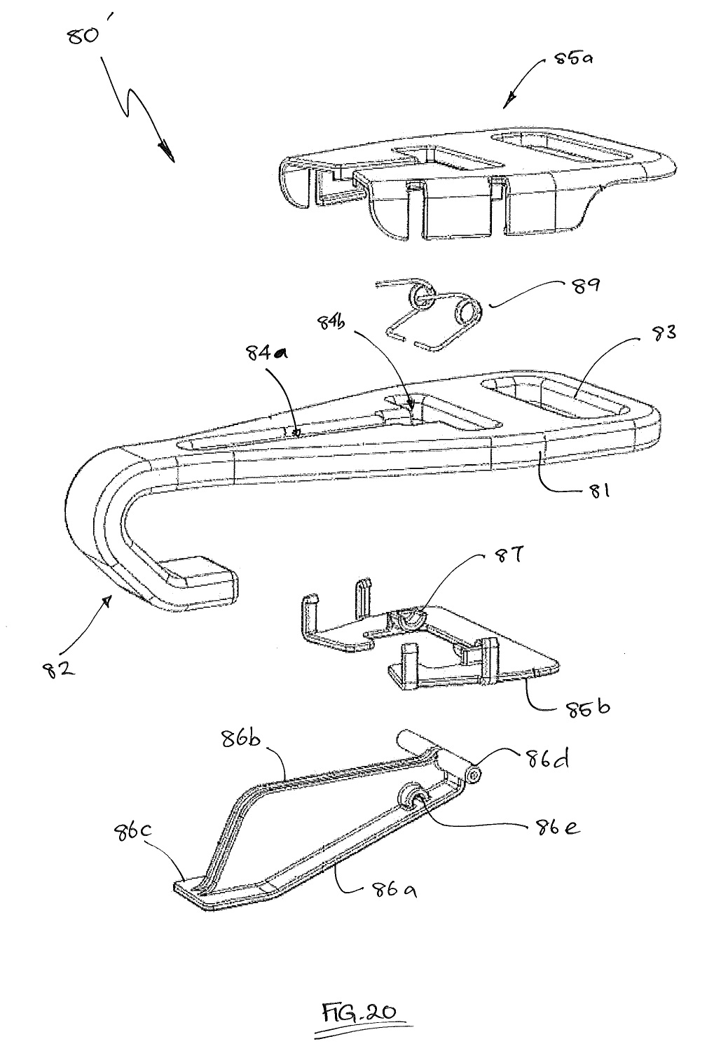

In order to move the anchorage device 80 into an open position, as is required to remove/attach the anchorage device 80 from/to an anchorage fitting of the vehicle, pressure is applied to the closing portion 86a of the retainer device 86 as shown in FIG. 19.

When pressure is applied to the closing portion 86a it overcomes the biasing forces present in the springs 88 to move the end lip 86c of the closing portion 86a away from contact with the hook portion 82. This provides a space between the outer surface of the closing portion 86a and the hook portion 82, as shown, through which the anchorage fitting may pass. As the locating portion 86b projects above the closing portion 86a, the narrow slot 84a provided in the main body 81 provides a path through which the locating portion 86b travels to facilitate such movement, as is shown in FIG. 19.

It will be appreciated that due to the presence of the biasing means or springs 88, upon release of the opening force, the retainer device 86 will be retainer device 86 will be returned to the closed position as depicted in FIG. 19.

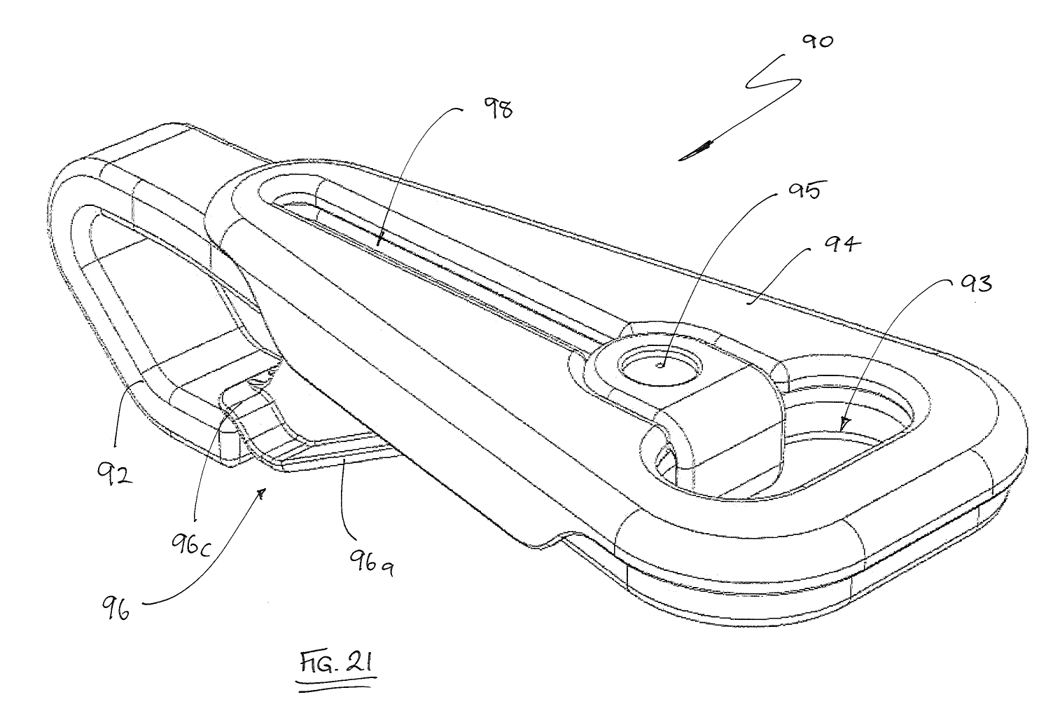

Referring to FIG. 20, a variation of the anchorage device 80′ is depicted. The anchorage device 80′ as shown, operates in substantially the same manner as the anchorage device 80 depicted in FIGS. 15-19, but rather than employing a biasing means comprising cylindrical compression springs, an alternative spring arrangement, in the form of a torsion spring 89, is employed.

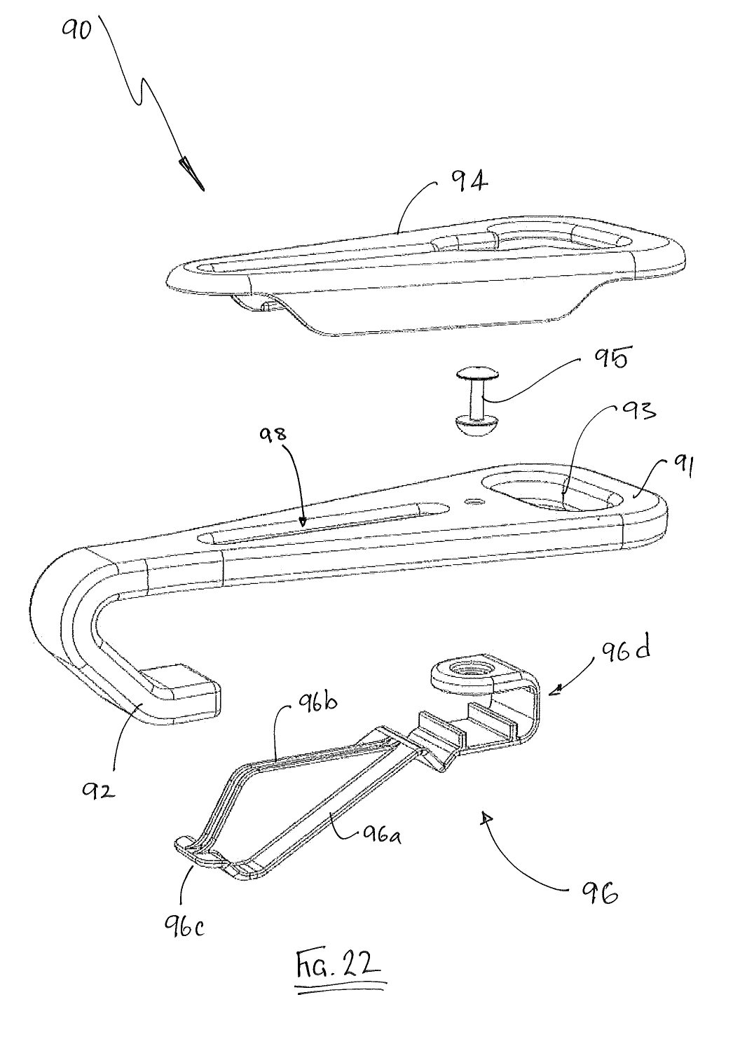

FIGS. 21 and 22 depict yet another embodiment of an anchorage device 90 in accordance with the present invention. The anchorage device 90 is a variation of anchorage device 80, 80′ described above.

The anchorage device 90 comprises a main body 91 having a hook portion 92 located at one end for engaging with a vehicle anchorage location or the like, and a laterally extending slot 93 provided at the opposing end. The laterally extending slot 93 is configured to receive a strap member (not shown) of an upper tethering system in the manner as discussed above in relation to the earlier embodiments. The main body 91 also has a longitudinally extending recess 98 formed therein in a central region thereof that extends between the hook portion 92 and the slot 93. The recess 98 functions to accommodate the locating portion 96b of the retainer device 96 as the retainer device is moved from the closed to the open position in much the same way as described in each of the previous embodiments.

An upper cover member 94 is configured to fit over the main body 91 as is shown in FIG. 21. The upper cover member 94 is shaped to conform to the main body 91 and has recesses that align with the slot 93 and recess 98, as shown.

The retainer device 96 has a clamp portion 96d that is fixedly mounted to the main body 91 by way of a fastening means 95. The fastening means 95 is depicted as a rivet; however, other means for fastening the retainer device 96 to the main body 91 are also envisaged.

The retainer device 96 comprises a closing portion 96a and a locating portion 96b. The closing portion 96a has an end lip 96c which is configured to be seated on the end of the hook portion 92 of the main body 91 so as to close the hook portion 82, as is shown in FIG. 21. In this arrangement, the closing portion 96a provides an outer closing surface of the anchorage device 90, which is to be depressed by a user in order to open the anchorage device 90. The locating portion 96b is located inwardly of the closing portion 96a and functions to provide an internal wall such that the anchorage fitting to which the anchorage device 90 is attached, is maintained within the region of the hook portion 92 of the main body 91, in the manner as discussed above in relation to anchorage device 80, 80′.

In order for the retainer device 96 to move between an open and closed position, the retainer device 96 is formed to be resiliently flexible about the clamp portion 96d. In this regard, any force against the closing portion 96a to move the closing portion 96a into the open portion will cause the closing portion 96a and the locating portion 96b to pivot about the clamp portion 96d. The recess 98 formed in the main body 91 provides a passage through which the locating portion 96b is able to pass to facilitate opening of the anchorage device 90, in the same manner as previously discussed. However, rather than provide a separate biasing means to return the retainer device 96 to the closed position, the resiliently flexible material and configuration of the retainer device 96 is such that a bias force is retained within the retainer device 96 to return to the closed position.

It will be appreciated that in each of the above embodiments of the present invention, the anchorage device for performing the connection between the upper tethering system of the child safety seat and the dedicated vehicle anchorage point is able to be simply de-activated to facilitate detachment of the device and removal of the child safety seat. The user is not required to loosen the tethering system at the child safety seat or manipulate it into a correct angle to allow disconnection, thereby reducing the difficulty and the time required to perform the task, as well as the effort, particularly when the vehicle anchorage point is often located in a difficult to access region of a vehicle. Each of the above referenced devices of the present invention also provides means for ensuring that the anchorage device is biased into a closed or locked position to enhance the safety characteristics of the device.

The anchorage device of the present invention differs from existing anchorage members used in isofix-type restraint systems. In such existing isofix-type restraint systems, the anchorage members employ an activation button on a rear surface thereof to open/close the anchorage member. Such systems are prone to inadvertent opening when in use, especially if contact is made to the rear of the anchorage member. The present invention provides the opening closing mechanism on a forward or central portion of the anchorage device, which significantly reduces the likelihood of the anchorage device inadvertently opening during use, and provides a more user friendly system for engaging/disengaging the anchorage device.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the child safety seat uppermost.

It will be appreciated by those skilled in the art that many modifications and variations may be made to the methods of the invention described herein without departing from the spirit and scope of the invention.

The claims defining the invention are as follows:

1. An anchorage device for releasably attaching a tethering system of a child safety seat to a vehicle anchorage point, comprising:
an open hook member configured to engage with a fitting provided on a vehicle anchorage point;
a closing member configured to co-operate with the open hook member to facilitate secure attachment of the device to the vehicle anchorage point;
an activation member operable to engage with either the open hook member or the closing member to facilitate movement of either the open hook member or the closing member to an open position whereby a gap is formed between the open hook member and the closing member to detach the device from the vehicle anchorage point; and
a biasing means for applying a biasing force to either the open hook member or the closing member such that under the biasing force the closing member cooperates with the open hook member to facilitate secure attachment of the device to the vehicle anchorage point.

2. An anchorage device according to claim 1, wherein the activation member is operable to move the closing member with respect to the open hook member to form said open position.

3. An anchorage device according to claim 2, wherein the closing member is located on the activation member.

4. An anchorage device according to claim 3, wherein the activation member is a slide member mounted on the open hook member and the closing member is a projection formed on the slide member.

5. An anchorage device according to claim 4, wherein when the slide member is in a first position the projection cooperates with the open hook member to close the open hook member, and when the slide member is in a second position the projection is located remote from the open hook member to form the gap to facilitate detachment between the device and the vehicle anchorage point.

6. An anchorage device according to claim 5, wherein movement between the first position and the second position is in the form of sliding movement performed along a common plane.

7. An anchorage device according to claim 5 or 6, wherein a stopper is provided on the hook member to engage with the slide member when the slide member is in the first position.

8. An anchorage device according to claim 7, wherein the stopper is in the form of a projection that extends from a surface of the hook member and engages with a recess provided in the slide member when the slide member is in the first position.

9. An anchorage device according to any one of claims 5-8, wherein the biasing means biases the slide member into the first position.

10. An anchorage device according to claim 1, wherein the activation member is operable to move the open hook member with respect to the closing member to form said open position.

11. An anchorage device according to claim 10, wherein the open hook member is pivotally mounted with respect to the closing member.

12. An anchorage device according to claim 11, wherein the activation member is provided on the open hook member.

13. An anchorage device according to claim 12, wherein the activation device is a lever portion formed at one end of the open hook member that is deflected to impart pivotal motion to the open hook member to move the open hook member between a closed position where the open hook member co-operates with the closing member and an open position where the open hook member is located remote from the closing member.

14. An anchorage device according to claim 12, wherein the activation device is a slide member slidably movable along the open hook member.

15. An anchorage device for releasably attaching a tethering system of a child safety seat to a vehicle anchorage point, comprising:
a body having an open hook portion at one end configured to engage with a fitting provided on the vehicle anchorage point and a slotted portion for facilitating connection with the tethering system;
a retainer member pivotally mounted to said body and movable between a closed position wherein the retainer member cooperates with the open hook portion to securely engage with the fitting and an open position, wherein the retainer member is positioned distal to said open hook portion to facilitate disengagement of the anchorage device with the fitting;
wherein the retainer member comprises a closing member configured to co-operate with the open hook member when in the closed position and a locating member integrally formed with said closing member, the locating member is configured to locate the fitting within the open hook portion of the body when the retainer member is in the closed position.

16. An anchorage device according to claim 15, further comprising a biasing means for biasing the retainer member into the closed position.

17. An anchorage device according to claim 16, wherein the biasing means comprises a torsion spring or a compression spring located between said retainer member and said body.

18. An anchorage device according to any one of claims 15-17, wherein the body comprises a recess formed therein, the recess being configured to accommodate the locating member of the retainer member as the retainer member moves from said closed to position to said open position.

19. An anchorage device according to claim 15, further comprising at least one cover member mountable to the body, the or each cover member being configured to securely attach the retainer member to the body.

20. An anchorage member according to claim 19, wherein an upper and a lower cover member are mountable to the body and cooperate to attach the retainer member to the body.
